(19) United States
(12) Patent Application Publication
(10) Pub. No.: US 2004/0187571 A1
(43) Pub. Date: Sep. 30, 2004

(54) Capacitive-type semiconductor sensor

(75) Inventor: Keisuke Goto, Obu-city (JP)

Correspondence Address: POSZ & BETHARDS, PLC, 11250 ROGER BACON DRIVE, SUITE 10, RESTON, VA, 20190, US

(73) Assignee: DENSO CORPORATION

(21) Appl. No.: 10/795,426

(22) Filed: Mar. 9, 2004

(30) Foreign Application Priority Data
Mar. 24, 2003 (JP) 2003-79801

(51) Int. Cl. G01P 9/00

(52) U.S. Cl. 73/504.14; 73/514.32

(57) ABSTRACT

A sensor chip for a semiconductor sensor includes, fixed electrodes, movable electrodes facing the fixed electrodes, and beams connected to the movable electrodes. Additional movable electrodes are provided between the beams and the fixed electrodes, which are closest to the beams. Thus, even when acceleration is applied, only the additional movable electrodes are brought into contact with the beams and hence no circuit shorting between the fixed electrodes and the beams is caused. As a result, a shield effect can be realized even though shield electrodes are not provided.

### CROSS REFERENCE TO RELATED APPLICATION

This application is based on and incorporates herein by reference Japanese Patent Application No. 2003-79801 filed on Mar. 24, 2003.

### FIELD OF THE INVENTION

The present invention relates to a capacitive-type semiconductor sensor for detecting a dynamic quantity such as acceleration on the basis of a capacitance of a capacitor comprising a fixed electrode and a movable electrode.

### BACKGROUND OF THE INVENTION

A sensor chip 100 of a capacitive-type acceleration sensor shown in FIGS. 3A to 3C has a configuration in which a capacitance of a capacitor comprises a fixed electrode 1 including arms 1a and 1b, and a movable electrode 2 including arms 2a. The arms 1a, 1b and the arm 2a face each other in the X direction to form a plurality of electrode pairs by providing grooves 11 on a semiconductor layer of a semiconductor substrate 10. The semiconductor substrate 10 is made of a material such as Si. The movable electrodes 2 have a shape resembling comb-teeth formed on a trunk 3, which extends in the X direction and functions as a weight, as teeth extended in ±Y directions. The two ends of the trunk 3 are formed on the semiconductor substrate 10 in such a way that the ends can be displaced in the X direction in response to accelerations. A beam 4 is formed on each of the ends of the trunk 3 as a beam that can be displaced in accordance with accelerations. The fixed electrodes 1 are arranged, each being extended in the ±Y directions, so that the fixed electrodes 1 face the movable electrodes 2 in the X direction. The fixed electrodes 1 are connected to pads 5a and 5b, which are made of a material such as Al. On the other hand, the movable electrodes 2 are connected to a pad 5c. The pads 5a, 5b and 5c are electrically conductive and connected to an external device, by bonding with wires, through pads of other circuit chips (not shown). Typically, the other circuit chips are mounted on a mother board (not shown).

When acceleration in the X direction is applied to the capacitive-type acceleration sensor, the beam 4 is displaced in the X direction, changing the distance between the arm 1a and the arm 2a as well as the distance between the arm 1b and the arm 2a. Thus, the capacitance CS1 of a capacitor comprising the arm 1a and the arm 2a as well as the capacitance CS2 of a capacitor comprising the arm 1b and the arm 2a also change.

An electric equivalent circuit of the capacitive-type acceleration sensor is shown in FIG. 4. When a pulse voltage Vcc is applied to the arms 1a and 1b, a resulting voltage corresponding to the difference ΔC (=CS1-CS2) between the capacitances CS1 and CS2 is produced from the arm 2a and converted into a voltage (=(CS1-CS2).Vcc/Cf) by using a switched-capacitor circuit 5. The resulting voltage can be detected as a physical or dynamic quantity representing the applied acceleration.

In the structure with the fixed electrodes 1 and the movable electrodes 2 formed into the comb-teeth shape, the fixed electrodes 1 are formed asymmetrically on the left and right sides of the trunk 3 located at the center between the fixed electrodes 1. That is, the positions of arms 1a and 1b are differentiated in the X direction between the left side and the right side of the trunk 3. In addition, the outermost side electrode adjacent to the beam 4 can be indeterminately a fixed electrode 1 or a movable electrode 2. In the case that the beam 4 deflects together with the movable electrodes 2 and the trunk 3, the beam 4 may short-circuit to the fixed electrodes 1. In order to avoid this short-circuiting, a dummy electrode is generally formed between the beam 4 and the fixed or movable electrode 1 or 2 adjacent to the beam 4 as a dummy electrode having an electric potential equal to the surrounding electric potential.

Further, it is necessary to provide shield electrodes 6 at locations, on the ends of which the fixed electrodes are formed, as shown in FIG. 5 and disclosed in JP-A-11-258089. Specifically, the upper left shield electrode 6 is provided between the beam 4 and the fixed electrode 1 whereas the upper right shield electrode 6 is provided between the beam 4 and the movable electrode 2. On the other hand, the lower right shield electrode 6 is provided between the beam 4 and the fixed electrode 1 whereas the lower left shield electrode 6 is provided between the beam 4 and the movable electrode 2. That is, in this typical configuration, the electrodes on the upper left and the lower right outermost sides are the fixed electrodes 1 (arms 1a, 1b). Those shield electrodes 6 require an increased chip area.

### SUMMARY OF THE INVENTION

It is thus an object of the present invention addressing the problem of the conventional capacitive-type acceleration sensor to provide a semiconductor sensor operable without any shield electrodes.

In order to achieve the above object, the present invention provides a semiconductor sensor characterized in that all electrodes provided on the outermost sides as electrodes adjacent to beams are movable electrodes. According to this construction, even when acceleration at least equal to a specification value is applied, the movable electrodes on the outermost sides are brought into contact with the beam so that no changes in output signal arise. This is because an electric potential appearing on each of the movable electrodes is equal to an electric potential appearing on the beam. As a result, a shield effect can be realized even though no shield electrodes are provided.

### BRIEF DESCRIPTION OF THE DRAWINGS

The above and other objects, features and advantages of the present invention will become more apparent from the following detailed description made with reference to the accompanying drawings.

FIG. 1 is a top plan view schematically showing a semiconductor sensor according to an embodiment of the present invention;

FIG. 2 is an enlarged view showing a principle to detect a capacitance provided by the semiconductor sensor shown in FIG. 1;

FIGS. 3A to 3C are a top plan view and two side sectional views schematically showing a conventional semiconductor sensor;

FIG. 4 is an electric circuit diagram showing a switched-capacitor circuit and an equivalent circuit of the conventional semiconductor sensor; and

FIG. 5 is a top plan view schematically showing another conventional semiconductor sensor having shield electrodes.

### DETAILED DESCRIPTION OF THE PREFERRED EMBODIMENT

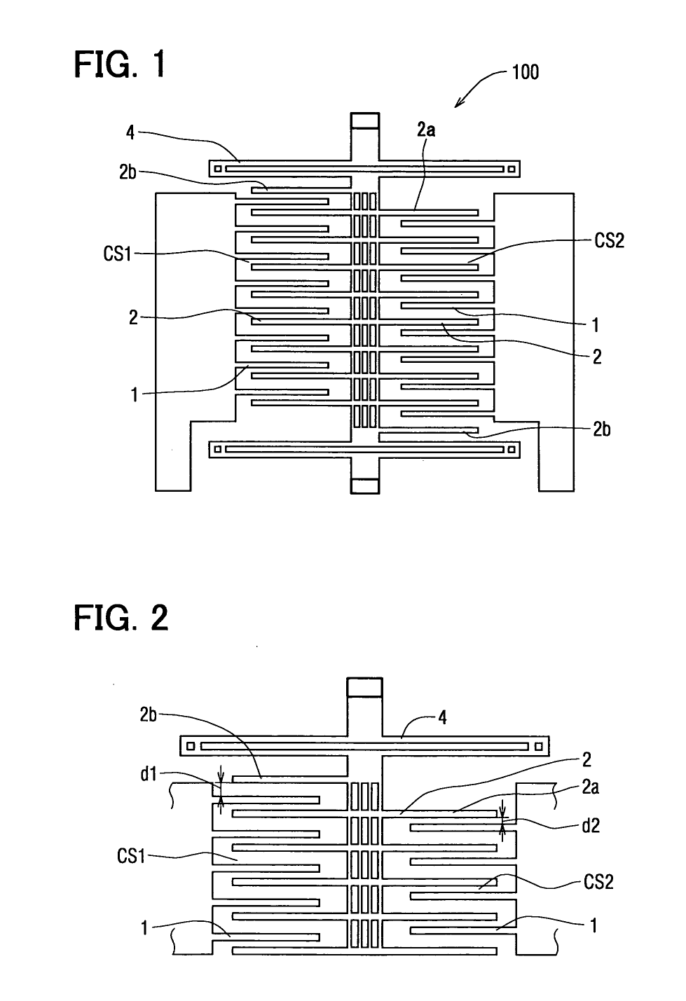

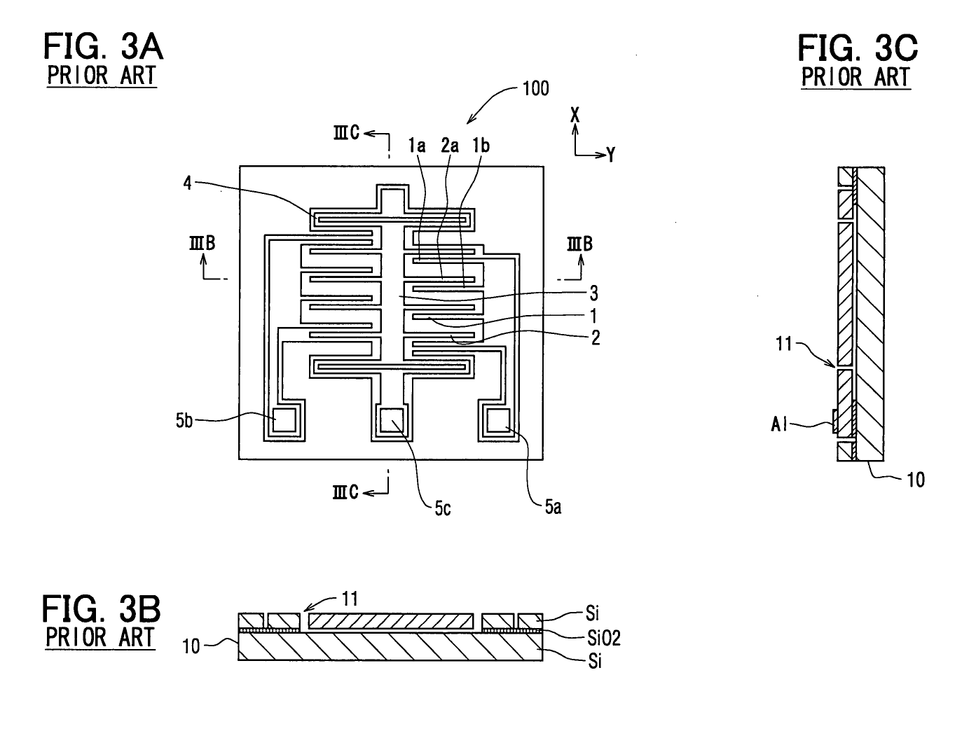

Referring to FIGS. 1 and 2, a sensor chip 100 according to an embodiment of a semiconductor sensor of the present invention is constructed similar to the conventional sensors shown in FIGS. 3A-3C and 5. The sensor chip 100 includes fixed electrodes 1, movable electrodes 2, a trunk 3 and beams 4. The sensor chip 100 has additional movable electrodes 2, particularly arms 2b as dummy electrodes, on the upper left and lower right outermost sides in the X direction so that the arms 2b are located only between the beams 4 and the fixed electrodes 1 in the X direction to restrict the beams 4 from contacting the fixed electrodes 1 when acceleration is applied.

In this configuration, all electrodes provided on the outermost sides are thus arms 2b of the movable electrodes 2. Thus, even when acceleration at least equal to a specification value is applied so that the movable electrodes 2 on the outermost sides are brought into contact with the beams 4, no changes in an output signal arise. This is because the electric potential appearing on each of the movable electrodes 2 is equal to the electric potential appearing on the beams 4. As a result, a shield effect can be realized even though shield electrodes such as shown in FIG. 5 are eliminated.

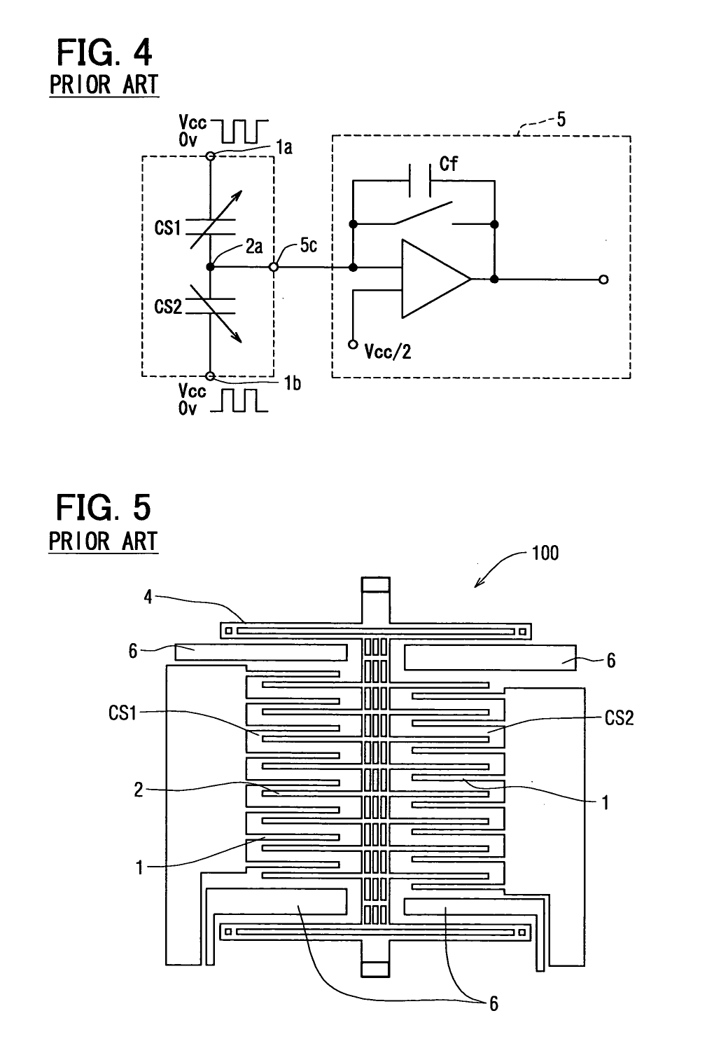

In the equivalent circuit shown in FIG. 4, a difference ΔC (=CS1- CS2) between the capacitances CS1 and CS2 is detected. Here, the capacitance CS1 is a capacitance of a capacitor comprising the movable electrode 2 and the fixed electrode 1 provided on one side as the fixed electrode adjacent to the specific movable electrode 2, whereas the capacitance CS2 is a capacitance of a capacitor comprising the movable electrode 2 and the fixed electrode 1 provided on the other side as the fixed electrode adjacent to the specific movable electrode 2.

In the configuration shown in FIG. 1, however, no fixed electrode is provided on the external side of each of the movable electrodes 2 provided on the outermost sides. In place of a movable electrode in the middle between the fixed electrodes on both sides, the movable electrode 2 is formed at a position closer to one of the fixed electrodes 1, that is, a position farther from the other fixed electrode 1 as shown in FIG. 2. More specifically, distances d1 and d2 between the electrodes 1 and 2 in FIG. 2 are differentiated to be d1>d2 and not equal to each other.

A one-side electrode structure for detecting only the capacitance CS2 is thus constructed to detect acceleration. In this structure, the movable electrode 2 is formed at a position closer to the CS2-capacitance side, that is, a position farther from the CS1-capacitance side, so that the capacitance CS1 practically does not function or the relation CS1≈0 holds due to the fact that the relation C∝∈.S/d holds true, where symbol C denotes capacitance, symbol ∈ denotes dielectric constant, symbol S denotes area of a gap between the facing electrodes and symbol d denotes distance between the electrodes.

The present invention should not be limited to the disclosed embodiment, but may be modified without departing from the spirit of the invention.

What is claimed is:

1. A semiconductor sensor comprising:
a plurality of fixed electrodes formed in a shape resembling comb-teeth;
a plurality of movable electrodes formed in a shape resembling comb-teeth and facing the fixed electrodes to form capacitances with the fixed electrodes; and
a beam connected to and displaceable with the movable electrodes in accordance with acceleration; and
an additional movable electrode provided between the beam and one of the fixed electrodes which is closest to the beam.

2. A semiconductor sensor according to claim 1,
wherein each particular one of the movable electrodes is provided at a position closer to one of the two fixed electrodes on both sides of the particular movable electrode, and
wherein only a capacitance of each capacitor comprising the particular movable electrode and the specific fixed electrode close to the particular movable electrode is detected.

3. A semiconductor sensor comprising:
a plurality of fixed electrodes formed in a shape resembling comb-teeth;
a plurality of movable electrodes formed in a shape resembling comb-teeth and facing the fixed electrodes to form capacitances with the fixed electrodes;
a beam connected to and displaceable with the movable electrodes in accordance with acceleration; and
a dummy electrode integral with the movable electrode and provided between the beam and one of the fixed electrodes thereby to restrict the beam from contacting the fixed electrodes.

4. A semiconductor sensor according to claim 3,
wherein the dummy electrode is provided only between the beam and the one of the fixed electrodes facing the beam.
